(19) United States
(12) Patent Application Publication
(10) Pub. No.: US 2016/0001674 A1
(43) Pub. Date: Jan. 7, 2016

(54) APPARATUS FOR PROVIDING AN ELECTRIC VOLTAGE WITH A SERIAL STACK CONVERTER AND A DRIVE ARRANGEMENT

(71) Applicant: SIEMENS AKTIENGESELLSCHAFT, Munchen (DE)

(72) Inventors: Dragan Mikulec, Erlangen (DE); Timur Werner, Erlangen (DE); Wolfgang Weydanz, Buckenhof (DE)

(73) Assignee: SIEMENS AKTIENGESELLSCHAFT, Munchen (DE)

(21) Appl. No.: 14/790,149

(22) Filed: Jul. 2, 2015

(30) Foreign Application Priority Data
Jul. 3, 2014 (DE) 10 2014 212 935.4

(51) Int. Cl. B60L 11/18

(52) U.S. Cl. CPC B60L 11/1866; B60L 11/1811; B60L 11/1803

(57) ABSTRACT

An apparatus for supplying an electric voltage includes a battery system supplying a battery voltage and having at least two serially-connected battery modules, with each of the battery modules supplying a battery module voltage, and at least two voltage converter modules, with each of the voltage converter modules being electrically connected to a respective one of the at least two battery modules and receiving at a battery module voltage and supplying electric power to a connected electric component.

### CROSS-REFERENCES TO RELATED APPLICATIONS

This application claims the priority of German Patent Application, Serial No. 10 2014 212 935A, filed Jul. 3, 2014, pursuant to 35 U.S.C. 119(a)-(d), the content of which is incorporated herein by reference in its entirety as if fully set forth herein.

### BACKGROUND OF THE INVENTION

The present invention relates to an apparatus for supplying an electric voltage with a battery system having at least two serially-connected battery modules.

The following discussion of related art is provided to assist the reader in understanding the advantages of the invention, and is not to be construed as an admission that this related art is prior art to this invention.

Apparatuses for providing an electric voltage usually include an electric energy store, which can be embodied as a battery system for example. Such battery systems can be used to supply electric loads, for example electric machines, with energy. Such electric machines can be disposed in motor vehicles for example and serve to drive the motor vehicle. Electric energy stores can also be used as buffer stores for electric energy. In such cases electric energy is provided by an electric machine in generator mode and is buffered in the electric energy store. Such electric energy stores are known for example from wind power systems or hybrid vehicles.

In the possible applications given above the battery systems are generally designed as high-voltage batteries which provide a high voltage as the battery system voltage. High-voltage here is to be understood as a voltage greater than 60 volts, especially greater than 120 volts. One or more loads can be connected to such an electric energy store, which are supplied by the battery with electric energy. Since the voltage provided by the battery is not equally suitable for all electric loads, the electric energy from the battery is usually transmitted via one or more voltage converters to the electric load or loads.

A circuit arrangement according to the prior art is shown in FIG. 1. Here a battery system 10 with an internal resistance R_{I} is connected electrically via a supply line having a parasitic inductance L_{I} to a series circuit to voltage converter modules 20. Connected to each of the voltage converter modules 20 is an electric load or an electric component 30.

The battery system 10 provides a battery system voltage U_{S} which is provided to the voltage converter modules 20 via an inductance L. The battery system voltage U_{S} is divided up between the voltage converter modules 20 such that, at each of the voltage converter modules 20 a partial voltage U_{T} of the battery system voltage U_{S} drops. The battery system voltage U_{S} is thus divided serially between a plurality of voltage converter modules 20, wherein the voltage converter modules 20 are connected in a series circuit to the battery system 10. The respective partial voltage U_{T} is thus dependent on the number of connected voltage converter modules 20 and is scaled via this number of voltage converter modules 20. The partial voltage U_{T} falling at a voltage converter module 20 is converted by means of the voltage converter module 20 into a voltage suitable for the electric component 30.

The disadvantage of the circuit arrangement according to FIG. 1—and thus of the prior art—is that the partial voltage U_{T} of each individual voltage converter module 20 is only scaled by the number of serially-connected and above all similar voltage converter modules 20, which brings with it restrictions in the scope of possible applications of the circuit arrangement.

It is also disadvantageous that a simultaneous operation of the battery system 10 as source or sink with the circuit arrangement according to the prior art is not possible. This means that it is not possible for example to provide a generator mode in which energy is fed back into the battery with the individual voltage converter modules 20 and simultaneously provide a motor mode with the remaining voltage converters 20, in which electric loads connected to the voltage converter modules can be supplied with energy.

A significant further disadvantage of the circuit arrangement according to the prior art is that the power output of each voltage converter module 20 must be approximately the same. To this end the voltage converter modules 20 coupled serially to one another are as a rule of identical design. In such cases each voltage converter module 20 is designed for a specific part voltage, also called intermediate circuit voltage. If the maximum permissible intermediate circuit voltage for each voltage converter module 20 is exceeded the voltage converter module will be destroyed. The maximum permissible intermediate circuit voltage per submodule will always be exceeded if the differences in the power output (motor mode) or power consumption (generator mode) respectively of the individual voltage converter modules 20 become very large. This means the intermediate circuit voltages of the individual voltage converter modules 20 can no longer be regulated if the sinks or sources of the individual voltage converter modules 20 deviate too greatly from one another.

Further disadvantages of the prior art emerge as a result of the restrictions in the current dimensioning of the batteries. A battery system or battery string or energy storage module is generally constructed by connecting battery modules one after the other, said arrangement usually comprising serial and/or parallel connected battery cells. The battery modules are always necessarily charged or discharged in this arrangement with the same current. The reason for this is that the individual battery modules are connected into a system with a higher voltage, i.e. into an energy storage module inflexibly in series and only the overall energy storage module can be accessed. Only the current which flows through the entire energy storage module can be regulated in such cases. The battery system voltage is proportional to the number of battery modules connected in series. High battery system voltages thus demand a large number of battery modules or cells connected in series and thereby make optimal battery design more difficult, which can lead to over-dimensioning and an additional increase in battery costs and system complexity. Furthermore the series connection makes greater demands on a battery management system (BMS), on safety and on energy storage module design, which again leads to increased costs.

On the other hand a pure parallel connection of the battery modules requires operation with low battery system voltage, which however, with high powers, leads to large battery currents and thus to higher power losses between battery and the loads. Realization is technically complex and expensive. Furthermore no scaling effects are produced here. The battery modules continue to represent a large and complex overall system. The redundancy and thus possible fault tolerance of the system is not increased by mere parallel connection of the battery modules.

It would therefore be desirable and advantageous to obviate prior art shortcomings and to provide an improved apparatus for supplying electric energy for one or more electric components in an especially cost-effective and optimized manner by using a redundant system that can be flexibly adapted to the power requirements of the electric components.

### SUMMARY OF THE INVENTION

According to one aspect of the present invention, an apparatus for supplying an electric voltage includes a battery system supplying a battery voltage and having at least two serially-connected battery modules, with each of the battery modules supplying a battery module voltage, and at least two voltage converter modules, with each of the voltage converter modules being electrically connected to a respective one of the at least two battery modules and receiving at an input the battery module voltage and supplying at an output electric power to a connected electric component.

In the apparatus, a battery module and a voltage converter module electrically connected to this battery module form a submodule. The partial voltage which is now present at the voltage converter module is no longer scaled in this case via the number of voltage converter modules connected to the battery system. In each submodule the voltage which is present at the voltage converter module is defined by the connected battery module. Each submodule thus forms a separate module voltage supply apparatus. The advantage produced by this is that the apparatus is embodied especially reliably with a high availability. On failure of a voltage converter module or of a battery module, i.e. of an individual submodule, the remaining voltage converter modules in combination with the associated battery modules, i.e. the remaining submodules, can continue to be operated without problems and can provide energy for at least one connected electric component. In addition the apparatus according to the invention can be scaled in any given way in its power, since the apparatus can be expanded by further submodules for increasing the power without influencing the submodules already present, especially the battery module voltage of the submodules, in doing so. Thus a low-cost, efficiency-optimized, redundant and flexible power supply can be realized with the apparatus.

According to an advantageous feature of the present invention, each battery module may include at least one battery cell or may include a series circuit or a parallel circuit of a plurality of battery cells. Thus each battery module can provide a different voltage from another battery module and can thus scale the battery system voltage. Each individual battery module can thus be dimensioned so that the connected voltage converter module can be operated at its optimum efficiency. Submodules with different voltage classes are thus able to be realized and loaded independently of one another. This obviates the need for a central control, which insures the even adaptation of the partial voltage to the respective voltage converter module.

According to another advantageous feature of the present invention, the apparatus may include at least one switching device which is disposed between the two battery modules for electrical connection and/or disconnection of the battery modules. When the battery modules and the switching device are electrically connected to one another a serial connection of the submodules can be made possible. The battery modules, and thus the submodules, can however also be galvanically isolated from one another if undesired coupling-in of electrical noise should occur between the submodules. The ability for the individual battery modules to be galvanically isolated from one another during operation enables the apparatus according to the invention to be especially flexibly disposed as regards space.

According to another advantageous feature of the present invention, the voltage converter module may have at least one voltage converter element which has a boost converter and/or a buck converter. Boost converters and buck converters, referred to generally as synchronous converters, are DC converters. A boost converter converts an input-side voltage into an output-side voltage of which the amount is larger than that of the input-side voltage. A buck converter converts an input-side voltage into an output-side voltage of which the amount is smaller than that of the input-side voltage. In particular each voltage converter element for each submodule can be designed to meet its demand and be embodied for a specific power requirement adapted to the submodule. This means that each voltage converter module and thus each submodule is flexibly designed and can provide a suitable voltage for an electric load or the electric component connected to the submodule.

According to another advantageous feature of the present invention, the voltage converter module may have at least two voltage converter elements which are connected electrically in parallel. This enables a submodule to be formed which has a battery module and a voltage converter module with at least two parallel-switched voltage converter elements. Through the parallel switching of the at least two voltage converter elements the current is summed at an output side of the voltage converter module, to which an electric load is able to be connected. This increased current can be provided to an electric load able to be connected thereto with higher power requirements for example. This produces a greater flexibility in current scaling and thus also the power scaling of the submodules, which can be achieved by the parallel connection of a number of voltage converter elements to a battery module.

According to another advantageous feature of the present invention, the at least one voltage converter element may have a power-electronic inverter for converting the battery module voltage into an AC voltage. This enables the battery module voltage provided by a battery module which is converted by means of a boost converter or a buck converter into a higher or lower output DC voltage compared to the battery module voltage present on the input side, to be transformed by the power electronic converter into an AC voltage. Thus an electric motor can be operated with a submodule for example.

According to another advantageous feature of the present invention, the power electronic converter may include an H-bridge and/or a two-stage converter. This enables an AC voltage with variable frequency, variable amplitude to be generated from a DC voltage. The inverter can be suitably selected for the requirements of each submodule. The submodules thus produced are thus decoupled such that they can be loaded independently of one another and can operate electric components, for example motors, with different power requirements.

According to another advantageous feature of the present invention, the battery module voltage which is present at the respective battery module may be less than 120 volts or preferably less than 60 volts. A DC voltage which is less than 120 volts or preferably less than 60 volts is generally no longer regarded as a high voltage but as a low voltage. This enables the requirements for (high-voltage) safety according to the relevant known standards to be dispensed with. Thus the use of special high-voltage connectors, of cables with high insulation strength as well as high-voltage interlock mechanisms and further safety measures are irrelevant. The high-voltage interlock is generally a monitoring facility of high-voltage plug-in connectors and is used for shock hazard protection. Likewise, with battery module voltages of less than 120 volts or preferably less than 60 volts, lower-cost components and protection concepts for lower voltages can be employed. Inter alia this makes possible the use of semiconductor switches for simple switching off of the individual 60 volt-based battery modules. This enables expensive and large relays to be dispensed with which are needed for switching higher powers at high voltage. Likewise in the event of damage, for example an accident, no “splitting up” of the batteries into subunits of lower voltage is necessary since all voltage converter modules already have voltages in the range of the safe low voltage. This is a measure often required specifically in the automobile industry, which however has not been able to be implemented satisfactorily to date.

According to another aspect of the present invention, a drive arrangement includes at least one apparatus according to the invention and at least one electric component which is connected electrically to the at least one apparatus according to the invention.

According to another advantageous feature of the present invention, the drive arrangement may include a control device designed to control the at least one switching device of the apparatus. The electric component may be embodied as an electric machine.

According to another advantageous feature of the present invention, when the electric component operates in a motor mode, at least one of the battery modules supplies electric energy to the respective electric component, and wherein when the electric component operates in a generator mode, the respective electric component supplies electric energy to the at least one battery module for charging the at least one battery module.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a circuit arrangement for power supply according to the prior art,

FIG. 2 shows a schematic diagram of a drive arrangement according to the prior art,

FIG. 3 shows a schematic diagram of a basic layout of a boost converter,

FIG. 4 shows a schematic diagram of an exemplary embodiment of the drive arrangement according to the present invention,

FIG. 5 shows a schematic diagram of the layout of the battery system of the apparatus according to the present invention, and

FIG. 6 shows a schematic diagram of a further form of another exemplary embodiment of the drive arrangement according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

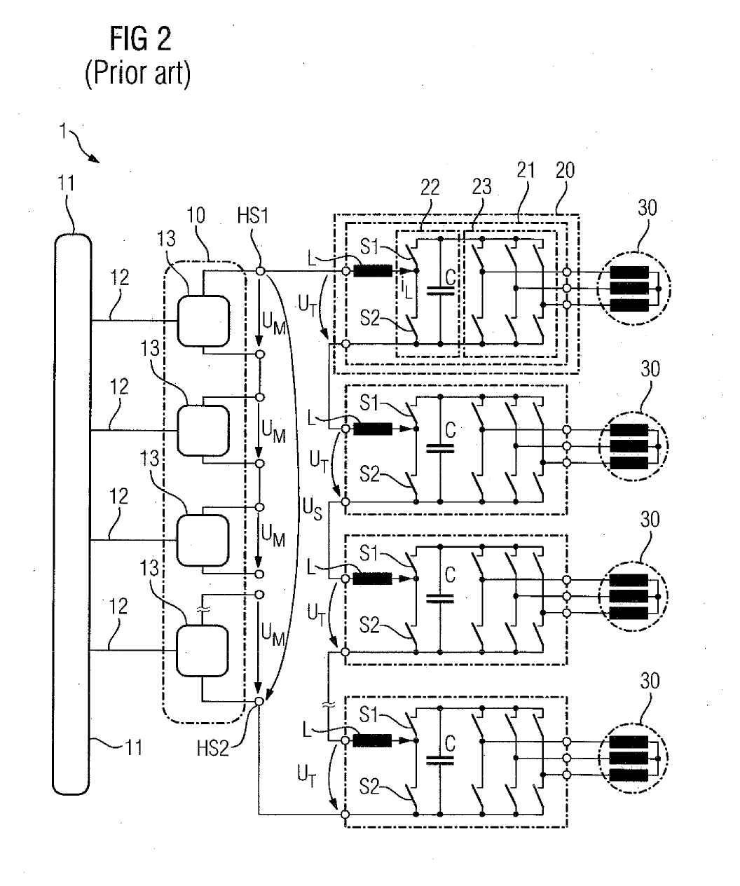

Turning now to the drawing, and in particular to FIG. 2, there is shown a drive arrangement 1 according to the prior art. The drive arrangement 1 comprises a battery system 10, especially a high-voltage battery, which is formed by a serial connection of battery modules 13. At each of the battery modules 13 a battery module voltage U_{M} drops, which sums into a battery system voltage U_{S}, which is able to be tapped off at main terminals HS1 and HS2 of the battery system 10. Connected to the main terminals HS1 and HS2 of the battery system 10 is a serial connection of voltage converter modules 20. The voltage converter modules 20 in the present exemplary embodiment are embodied identically. The battery system voltage U_{S} is divided equally between the individual voltage converter modules 20, wherein at each voltage converter module 20 a partial voltage U_{T} of the battery system module U_{S} drops. The amount of the partial voltage U_{T} is dependent on the number of voltage converter modules 20, which are connected to the battery system 10, and can also be scaled only via this number. Connected to each voltage converter module 20 is an electric component 30, for example an electric machine, especially an electric motor. A control device 11, which is connected in each case via a control bus 12 to a battery module 13, serves for example to control, regulate and monitor motor functions.

The DC voltage provided by the battery system 10, which is divided up as a partial voltage U_{T} serially to the connected voltage converter modules 20, is converted upwards in each case via a voltage converter element 21 into a voltage suitable for an electric motor and is converted into an AC voltage. To this end the partial voltage U_{T} is applied via a choke inductance L to a boost converter 22.

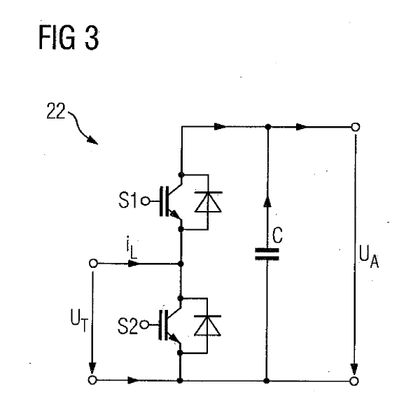

The circuit topology of a boost converter 22 is shown in FIG. 3. The boost converter 22 comprises two switching elements S1 and S2, which can be embodied as semiconductor switches. The boost converter 22 further comprises a charge capacitor C, at which an output voltage U_{A} drops. If the switching element S2 is closed, then the partial voltage U_{T} is present at the upstream choke inductance L and a current i_{L} flows through the choke inductance L into the boost converter 22. When the switching element S2 is opened and the switching element S1 is closed, the current i_{L} flows via the switching element S1 into the charge capacitor C, where the magnetic energy of the choke inductance L is converted into electric energy. Through this the output voltage U_{A}, which is present at the charge capacitor C, increases. The partial voltage U_{T} is thus converted by means of the boost converter 22 into the output voltage U_{A}, of which the amount is greater than that of the partial voltage U_{T}. The output voltage U_{A} can be converted by means of an inverter 23 into an AC voltage.

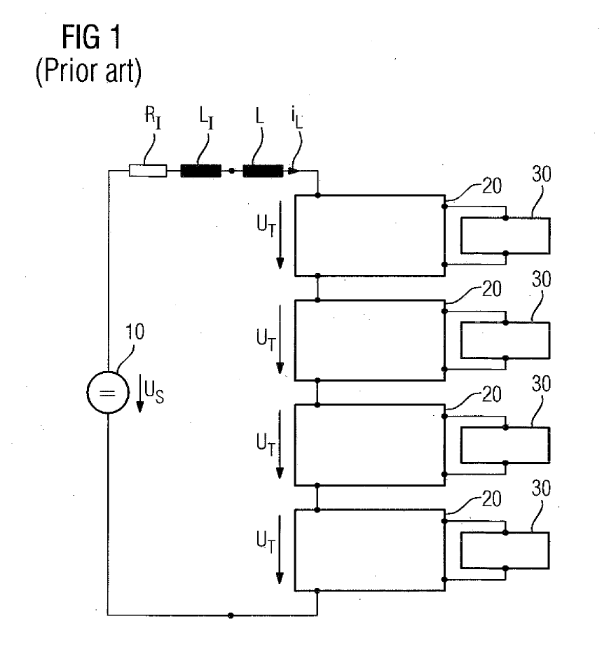

If the boost converter 22 from FIG. 3 is used in the circuit arrangement according to FIG. 1 or the drive arrangement 1 according to FIG. 2, then the circuit arrangement can exhibit weaknesses as regards reliability and availability. If for example there is a partial failure of the semiconductor switch S2 of one of the voltage conversion modules 20, i.e. a low-resistance short-circuit of for example less than or equal to 100 milliohm is created, destruction of the remainder of the voltage converter module 20 is very probable. In the circuit topology according to the prior art this can only be prevented by all semiconductor switches S1 and S2 of all voltage converter modules 20 basically being dimensioned so that they can compensate for the failure of at least one voltage converter module 20. This means that all semiconductor switches S1 and S2 must be over-dimensioned or must be designed for a higher intermediate circuit voltage, i.e. for a higher partial voltage U_{T}, since on failure of a voltage converter module 20, the respective partial voltage U_{T} at the other voltage converter modules increases. This worsens the efficiency of the circuit arrangement, since the forward power losses of the semiconductor switches S1 and S2 are increased. The system costs are greatly increased as well. In addition, as a result of the serial coupling of the voltage converter modules 20 in the circuit arrangement according to FIG. 1 and FIG. 2, the voltage converter modules 20 are loaded symmetrically and evenly where possible. Therefore only stator-fed motors or motors fed on one side are suitable as electric components 30 or load.

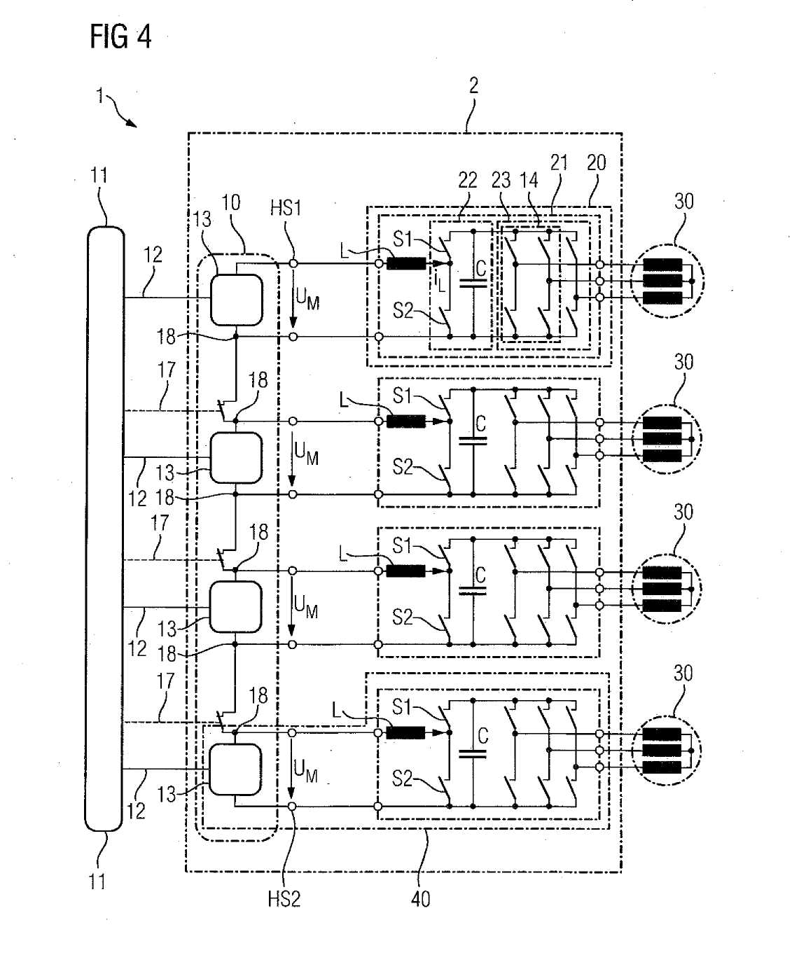

FIG. 4 now shows a schematic diagram of a drive arrangement 1 with an inventive apparatus 2. The apparatus can also be referred to as a serial stack converter. The drive arrangement 1 with the apparatus 2 can for example be disposed in a motor vehicle and can serve to supply power to the electric components 30, especially electric machines. The four electric machines 30 shown here can be wheel hub motors for example, wherein one wheel hub motor can be disposed on each of the four wheels of the motor vehicle in each case. The wheel hub motors serve to drive the four wheels of the motor vehicle. The electric components 30 can however be other loads of the motor vehicle. A control device 11 which communicates via the control busses 12 with the apparatus 2 is used for control, regulation and monitoring of the motor functions.

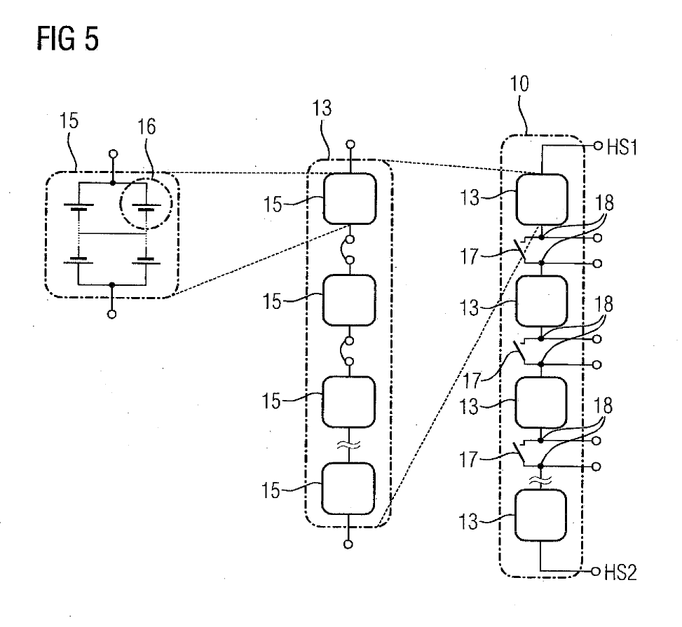

To supply energy to the electric machines 30 the serial stack converter or the apparatus 2 has a battery system 10, especially a high-voltage battery. The layout of the battery system 10 is shown in FIG. 5. In the battery system 10 a number of battery cells 16 are usually connected together serially and/or in parallel into an individual battery module 15. The serial interconnection of the individual battery modules 15 produces a battery module 13, which is also referred to as battery stack. The battery modules 13 are interconnected serially into a battery system 10, which is also referred to as a battery pack. Between the individual battery modules 13 switching devices 17 are provided. A switching device 17 is designed to connect two battery modules 13 electrically and/or to disconnect them galvanically. A battery module voltage U_{M} drops or is present at each battery module 13, which sums into a battery system voltage U_{S}. The battery system voltage U_{S} is able to be tapped off between the main terminals HS1 and HS2.

The battery system 10 with the battery modules 13 and the switching devices are 17 according to FIG. 4 is intended for supplying the electric components 30 with power. Voltage taps 18 are disposed between the individual battery modules 13 of the battery systems 10, via which a voltage converter module 20 can be connected to each battery module. The battery module voltage U_{M} of a battery module 13 now drops as a partial voltage at the respective voltage converter module 20 which is electrically connected to the battery module 13. The battery module voltage U_{M} dropping at the respective voltage converter module 13 is independent of the number of voltage converter modules 20 which are connected to the battery system 10.

A voltage converter module 20 is thus expanded by its own battery module 13. A submodule 40 produced in this way is thus decoupled from the other, similarly-embodied submodules, such that the individual submodules 40 can be loaded independently of one another. Switching devices 17 which are able to be controlled via the control device 11 are disposed between the individual battery modules 13. Via the switching devices 17 the battery modules 13, and thus also the submodules 40 can be connected to one another electrically, wherein in the closed state of the switching devices 17 a series circuit of the individual submodules 40 is provided. The submodules 40 can however also be separated galvanically from one another by the switching devices 17, should undesired coupling-in of noise between the submodules 40 occur.

In addition the submodules 40 can be operated independently of one another. For example one submodule 40 can be in a generator mode. Then for example energy is provided in a charge mode by the connected electric component 30 which in this case is operated as a generator, which is supplied via the voltage converter module 20, which especially allows a bidirectional energy flow, to the connected battery module 13 to charge the battery module 13. Meanwhile another submodule 40 can be in a motor mode, wherein the electric component 30 of this submodule 40 is supplied with energy via the submodule 40. Through this high flexibility the battery system voltage U_{S} can be adapted to any given charging voltage without having to make large changes to the overall drive system. This leads to the development times and development costs of the drive arrangement 1 being greatly reduced.

The voltage converter modules 20, as described in FIG. 2, each have a voltage converter element 21 with a choke inductance L, a boost converter 22, which has two switching elements S1 and S2 and a charge capacitor C, as well as a power electronic converter, especially an inverter 23. The power electronic converter in such cases can be a two-stage converter or an H-bridge consisting of two half bridges 14. Through the expansion of a voltage converter module 20 by its own battery module 13 the battery module voltage U_{M} first submodule 40 is reduced to such an extent that the inverter function of the voltage converter element 21 can be realized in an especially advantageous way with MOSFET technology. Thus the switching elements S1 and S2, as well as the elements of the half bridges 14, can be optimally dimensioned and for example designed as MOSFETs, in particular they do not have to be over-dimensioned. This means that a demand-driven voltage class of MOSFETs can be used for each submodule 40, which is optimized to the respective submodule 40. The submodules 40 can thus consist of different voltage classes and/or different semiconductor classes.

In order to achieve any given power scaling of the serial stack converter or of the apparatus 2, the number of battery modules 13 in combination with voltage converter modules 20 can be varied. In particular a redesign of the entire serial stack converter or the apparatus 2 is not necessary since the serial stack converter, for power scaling, can merely be expanded by “standardized” submodules 40.

It is especially advantageous for the battery module voltage U_{M} (or the voltage potential in relation to bodywork of the motor vehicle) to always be less than 60 volts. If there is no charging mode the switching devices 17, which can be controlled via the electronic control device 11, are open in this case. If the switching devices 17 can remain permanently opened and charging of the individual battery modules 13 with below 60 volts can be guaranteed, then the requirements for high-voltage safety, in accordance with ISO 6469 for example, also do not apply. The disadvantage of a possible battery module partial voltage U_{M} which is too low is compensated for in that the boost converter 22 disposed in the voltage converter element 21 boosts the intermediate circuit voltage of the inverter 23 to the desired voltage value or regulates it according to operating point and thus optimized for efficiency.

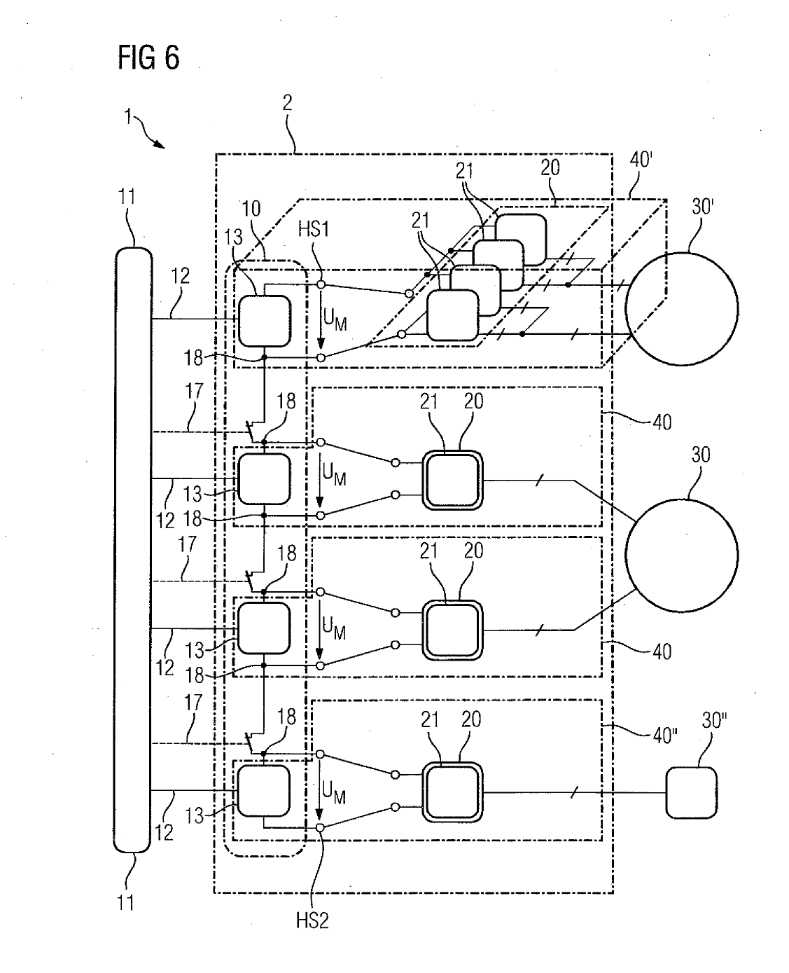

FIG. 6 shows a further form of embodiment of a drive arrangement 1. In this arrangement a number of battery modules 13 of the battery system 10 are electrically connected via voltage taps 18 in each case to a voltage converter module 20 into submodules 40, 40′ and 40″. The submodules 40, 40′ and 40″ are connected via switch devices 17, which can be controlled by means of the control device 11 via the control buses 12, serially to the apparatus 2. In each of the submodules 40, 40′ and 40″ the battery module voltage U_{M} provided by the respective battery module 13 is present at the connected voltage converter module 20.

Within the upper submodule 40′ the voltage converter module 20 includes a number of parallel-connected voltage converter elements 21, to which an electric component 30′, especially an electric motor, is connected. The parallel connection of the voltage converter elements 21 is used for current scaling. If the voltage converter elements 21, which—as described in FIG. 2 and FIG. 4—have a choke inductance L, a boost converter 22 and an inverter 23, are additionally clocked offset, then the frequency of a parasitic ripple current in the connected battery module 13 can be increased and thus the size of the choke inductance L can be greatly reduced.

In the present exemplary embodiment a single electric component 30 is connected to the two central submodules 40. Through this the electric component 30 is supplied with twice the battery module voltage U_{M}. The serial connection of the submodules 40, to which the electric component 30 is connected, serves to scale the voltage.

The lower submodule 40″ supplies an electric component 30″, which is referred to here as the DC load, with energy. The voltage converter element 21 of the voltage converter module 20 is embodied here for example as a synchronous converter, especially as a boost converter. There is no provision for a conversion of the DC voltage provided by the battery system 10 into an AC voltage within the submodule 40″, since the DC load is supplied with a DC voltage.

The apparatus 2 or the serial stack converter, of which typical forms of embodiment are shown in the drive arrangement 1 from FIG. 4 and from FIG. 6, is able to be loaded unsymmetrically. Therefore double-fed induction machines and remotely-excited synchronous machines likewise can be used as electric components 30 for example. A three-phase source as well as an additional DC source necessary for this class of motors can be supplied at the same time by the apparatus 2. This is of advantage since above all remotely-excited synchronous machines can have particular efficiency advantages for electrified vehicles in a wide area of operation.

Thus an apparatus 2 can be provided the form of the serial stack converter, which is used for diverse topologies and can meet a wide diversity of performance and voltage requirements. Thus for example, as well as the use of drive arrangement with such a stack converter in a motor vehicle, there can also be provision for use in a wind power system. In addition such a drive arrangement can be flexibly scaled with standardized submodules. Through the standardization the advantages of low-cost repairs for an end customer, a high redundancy of the drive arrangement 1, a high robustness through use of proven components from proven production processes as well as a marked reduction in manufacturing costs with increased quality and flexibility are also produced.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An apparatus for supplying an electric voltage, comprising
a battery system supplying a battery voltage and comprising at least two serially-connected battery modules, with each of the battery modules supplying a battery module voltage, and
at least two voltage converter modules, with each of the voltage converter modules being electrically connected to a respective one of the at least two battery modules and receiving at an input the battery module voltage and supplying at an output electric power to a connected electric component.

2. The apparatus of claim 1, wherein each battery module comprises at least one battery cell or a series connection or a parallel connection of a plurality of battery cells.

3. The apparatus of claim 1, comprising at least one switching device disposed between adjacent ones of the at least two battery modules and configured to connect or disconnect the at least two adjacent battery modules to/from one another.

4. The apparatus of claim 1, wherein a voltage converter module comprises at least one voltage converter element having a boost converter or a buck converter, or both.

5. The apparatus of claim 4, wherein the voltage converter module comprises at least two voltage converter elements electrically connected in parallel.

6. The apparatus of claim 4, wherein the at least one voltage converter element comprises a power-electronic converter configured to convert the battery module voltage to an AC voltage.

7. The apparatus of claim 6, wherein the power-electronic converter comprises an H-bridge or a two-stage converter.

8. The apparatus of claim 1, wherein the battery module voltage present at a respective battery module is less than 60 volts.

9. A drive arrangement comprising
at least one apparatus having a battery system supplying a battery voltage, wherein the battery system comprises at least two serially-connected battery modules, with each of the battery modules supplying a battery module voltage, and at least two voltage converter modules, with each of the voltage converter modules being electrically connected to a respective one of the at least two battery modules and receiving at an input the battery module voltage and supplying electric power at an output, and
at least one electric component electrically connected to the output of the at least one apparatus in one-to-one correspondence.

10. The drive arrangement of claim 9, further comprising a control device configured to control at least one switching device disposed between adjacent ones of the at least two battery modules, with the at least one switching device configured to connect or disconnect the at least two adjacent battery modules to/from one another.

11. The drive arrangement of claim 9, wherein the at least one electric component is embodied as an electric machine.

12. The drive arrangement of claim 9, wherein when the electric component operates in a motor mode, at least one of the battery modules supplies electric energy to the respective electric component, and wherein when the electric component operates in a generator mode, the respective electric component supplies electric energy to the at least one battery module for charging the at least one battery module.
